(19) United States
(12) Patent Application Publication
(10) Pub. No.: US 2026/0111517 A1
(43) Pub. Date: Apr. 23, 2026

(54) METHOD FOR RECOGNIZING AN EVENT AND METHOD FOR GENERATING A MATCHED FILTER ARRANGEMENT

(71) Applicant: Robert Bosch GmbH, Stuttgart (DE)

(72) Inventor: Emil Winzell, Kista (SE)

(21) Appl. No.: 19/360,212

(22) Filed: Oct. 16, 2025

(30) Foreign Application Priority Data
Oct. 22, 2024 (DE) 10 2024 210 169.9

(51) Int. Cl. G06F 18/2113; G06F 123/02

(52) U.S. Cl. CPC G06F 18/2113; G06F 2123/02; G06F 2218/14

(57) ABSTRACT

A computer-implemented method for recognizing an event. The method includes: receiving sensor data from at least one sensor unit using an event recognition unit, wherein the sensor data are in the form of time series data and depict the event; filtering the sensor data using a matched filter arrangement of the event recognition unit and generating filtered sensor data; and recognizing the event based on the filtered sensor data using the event recognition unit. A method for generating a matched filter arrangement is also described.

### CROSS REFERENCE

The present application claims the benefit under 35 U.S.C. § 119 of Germany Patent Application No. DE 10 2024 210 169.9 filed on Oct. 22, 2024, which is expressly incorporated herein by reference in its entirety.

### FIELD

The present invention relates to a method for recognizing an event using a matched filter and a method for generating a matched filter arrangement.

### BACKGROUND INFORMATION

Certain methods for recognizing events using matched filters are described in the related art.

### SUMMARY

It is an object of the present invention to provide an improved method for recognizing an event and an improved method for generating a matched filter arrangement.

The object may be achieved by the methods of the present invention disclosed herein. Advantageous embodiments of the present invention are disclosed herein.

According to one aspect of the present invention, a computer-implemented method for recognizing an event is provided.

According to an example embodiment of the present invention, the method includes:
receiving sensor data from at least one sensor unit by means of an event recognition unit, wherein the sensor data are in the form of time series data and depict the event;
filtering the sensor data through a matched filter arrangement of the event recognition unit and generating filtered sensor data, wherein the matched filter arrangement exhibits a temporal progression that at least partially matches a temporal progression of the sensor data depicting the event and is optimized for filtering the sensor data depicting the event, wherein the matched filter arrangement comprises at least a first matched sub-filter and a second matched sub-filter, wherein the first and second matched sub-filters are in each case designed as a matched filter, wherein the first matched sub-filter exhibits a first temporal progression that at least partially matches the temporal progression of the sensor data in a first time segment of the sensor data and is optimized for filtering the first time segment of the sensor data depicting the event, and wherein the second matched sub-filter exhibits a second temporal progression that at least partially matches the temporal progression of the sensor data in a second time segment of the sensor data and is optimized for filtering the second time segment of the sensor data depicting the event; and recognizing the event on the basis of the filtered sensor data by means of the event recognition unit.

This can achieve a technical advantage that an improved method for recognizing an event can be provided. Here, the recognition of the method is based on sensor data, which are in the form of time series data and filtered using a matched filter arrangement. The matched filter arrangement is designed as a matched filter and comprises a plurality of matched sub-filters. The plurality of matched sub-filters are in each case adapted to individual time segments of the time-series signal of the sensor data and in each case exhibit temporal progressions that correspond to the temporal progression of the sensor data. By the fact that the plurality of matched sub-filters in each case span only a time segment that represents only a part of the temporal progression of the sensor data in the form of time series data, the matched filter arrangement can provide a matched filter that, if applicable, does not filter the complete temporal progression of the time series data of the sensor data. This can achieve the advantage that the matched filter arrangement, which is correspondingly reduced in size and stored in the event recognition unit for recognizing the event, occupies less memory space and requires less CPU power for execution.

According to one example embodiment of the present invention, the first matched sub-filter is optimized for filtering a first characteristic feature of the sensor data depicting the event, and/or wherein the second matched sub-filter is optimized for filtering a second characteristic feature of the sensor data depicting the event.

This can achieve a technical advantage that, by aligning the matched sub-filters to characteristic features of the sensor data, the matched filter arrangement can be further reduced in its scope and thus only filters parts of the sensor data in the form of time series data. By focusing the matched sub-filters on characteristic elements of the temporal progression of the sensor data, optimal filtering of the sensor data can still be achieved, which makes it possible to perform event recognition based on this.

According to one example embodiment of the present invention, the first and/or second characteristic feature of the sensor data are in each case formed as a portion of the sensor data having a signal-to-noise ratio reaching or exceeding a predefined limit value and/or having a variance between different sensor data depicting the same event reaching or falling below a further predefined limit value.

This can achieve a technical advantage that optimal filtering of the sensor data is made possible by the matched filter arrangement.

According to one example embodiment of the present invention, the first and second temporal progressions of the first and second matched sub-filters in each case exhibit a peak shape.

This can achieve a technical advantage that the matched sub-filters can effect a precise depiction of the temporal progression of the time series data of the sensor data in the respective time segments.

According to one example embodiment of the present invention, the first and second temporal progressions of the first and second matched sub-filters in each case exhibit a shape of a sinusoidal half-oscillation.

This can achieve a technical advantage of generating the temporal progressions of the matched filters having the simplest possible peak shapes. As a result, the matched filters can be further reduced in complexity, by which the memory requirements and/or the required CPU power is/are further reduced. Furthermore, simplified amplitude scaling can be effected.

According to one example embodiment of the present invention, the first and second matched sub-filters are in each case stored in the event recognition unit with a predefined identifier and information with respect to the first and second time segments, wherein the first and second matched sub-filters are in each case uniquely identifiable via the identifiers.

This can achieve a technical advantage of making it possible that the matched sub-filters stored in the event recognition unit are clearly taken into account for the matched filter arrangements.

According to one example embodiment of the present invention, the matched filter arrangement is stored as an assignment specification in the event recognition unit, wherein the assignment specification assigns the first and second matched sub-filters to a predefined filter sequence, and wherein the filtering comprises:
reading the assignment specification and arranging the first and second matched sub-filters in the predefined filter sequence.

This can achieve a technical advantage that the stored matched sub-filters can be used for different matched filter arrangements. The matched filter arrangement is defined as a predefined temporal arrangement of predefined matched sub-filters. Thus, the matched filter arrangements do not represent an actual filter stored in the event recognition unit. Instead, the matched filter arrangement is formed by arranging the different matched sub-filters accordingly in time. Here, the matched filter arrangement is formed at the point in time the sensor data are filtered by the particular matched filter arrangement. Here, the actually stored filter objects are reduced to the matched sub-filters. The matched filter arrangements, on the other hand, can only be generated at the point in time of executing the filtering process by arranging the matched sub-filters accordingly in time. As a result, the amount of storage space required can be further reduced.

According to one example embodiment of the present invention, a plurality of matched filter arrangements and a plurality of matched sub-filters are stored in the event recognition unit, wherein the different matched filter arrangements are in each case optimized for filtering sensor data depicting different events.

This can achieve a technical advantage of making possible the recognition of different events by taking into account a plurality of different matched filter arrangements, which in each case are optimized for filtering sensor data in each case depict different events. Each matched filter arrangement is optimized for a specific event and only generates the optimized filter result for sensor data that represents the particular event. As a result, different events can be recognized.

According to one example embodiment of the present invention, at least one matched sub-filter is assigned to at least two different matched filter arrangements.

This can achieve a technical advantage that, by using a matched sub-filter for different matched filter arrangements, the required memory capacity can be further reduced.

According to one example embodiment of the present invention, recognizing the event comprises:
ascertaining a first peak in the first time segment and a second peak in the second range of the filtered sensor data; and
interpreting the first peak in the first time segment as optimal filtering of the first time segment of the sensor data by means of the first matched sub-filter and interpreting the second peak in the second time segment of the filtered sensor data as optimal filtering of the second time segment of the sensor data by means of the second matched sub-filter;
interpreting the optimal filtering of the first time segment of the first sensor data by means of the first matched sub-filter and the second time segment of the sensor data by means of the second matched sub-filter as optimal filtering of the sensor data by the matched filter arrangement; and interpreting the optimal filtering of the sensor data by means of the matched filter arrangement optimized for filtering sensor data depicting the event as the presence of the event in the sensor data.

This can achieve a technical advantage that precise detection of the event depicted by the sensor data is achieved by using the matched filter arrangement. By filtering the sensor data using the matched filter arrangement, which corresponds to a convolution between the sensor data and the matched filter arrangement, filtered sensor data having a plurality of peaks are generated. Here, the peaks are created by convolving the sensor data having the matched filter arrangement, wherein the matched filter arrangement exhibits a temporal progression that largely corresponds to the temporal progression of the sensor data in the form of time series data. By checking the position of the peaks in the filtered sensor data, it can thus be ascertained that, due to the particular matched filter arrangement, the optimal filtering of the sensor data was effected. Since the matched filter arrangement is optimized for filtering sensor data that exactly depict the particular event, it can be concluded that the original sensor data actually depicted the event being sought. Since each matched filter arrangement is optimized only for filtering sensor data that depict a predefined event, precise event recognition can be effected by using the corresponding matched filter arrangement.

According to one example embodiment of the present invention, the sensor data are data from an acceleration sensor and/or a gyroscope sensor, and/or wherein the event is a gesture of a person.

This can achieve a technical advantage that movements, and in particular gestures, of persons can be recognized as events.

According to one aspect of the present invention, a computer-implemented method for generating a matched filter arrangement for use in event recognition according to one of the above-described embodiments is provided. According to an example embodiment of the present invention, the method comprises: receiving a plurality of data sets of sensor data from at least one sensor unit, wherein the sensor data are in the form of time series data and depict the event;
ascertaining characteristic features within the temporal progressions of the sensor data of the plurality of data sets;
adapting peak functions to the characteristic features of the temporal progressions of the sensor data and ascertaining a peak position value and/or a peak amplitude value and/or a peak width value for each peak function;
generating the matched sub-filters according to temporal progressions of the peak functions, wherein the matched sub-filters exhibit temporal progressions that at least partially match the temporal progressions of the peak functions; and arranging the matched sub-filters according to the position values relative to one another as a matched filter arrangement, wherein the matched filter arrangement exhibits a temporal progression that at least partially matches the temporal progression of the sensor data and is optimized to filter the sensor data depicting the event.

This can achieve a technical advantage that an improved method for generating a matched filter arrangement for using event recognition having the technical advantages described above can be provided.

According to one example embodiment of the present invention, the method comprises:
grouping the peak functions ascertained for the same event from sensor data of different data sets according to the position values and/or the amplitude values and/or the peak width values; and
averaging the grouped peak functions and generating averaged peak functions.

This can achieve a technical advantage that by averaging the peak functions and generating averaged peak functions, a smaller number of peak functions and in particular matched sub-filters have to be stored in the event recognition unit. As a result, the required storage space of the generated matched filter arrangement can be further reduced.

According to one example embodiment of the present invention, the sensor data are in the form of multidimensional sensor data, wherein the generation of the matched sub-filters is performed separately for the different dimensions of the sensor data.

This can achieve a technical advantage that a precise generation of the matched filter arrangement is made possible, wherein the matched filter arrangement can be applied to different dimensions of the sensor data.

According to one aspect of the present invention, a computing unit is provided, which is configured to perform the method for recognizing an event according to one of the above-described embodiments and/or the method for generating a matched filter arrangement according to one of the above-described embodiments.

According to one aspect of the present invention, a computer program product comprising instructions is provided, which, when the program is executed by a data processing unit, cause the data processing unit to perform the method for recognizing an event according to one of the above-described embodiments and/or the method for generating a matched filter arrangement according to one of the above-described embodiments.

Example embodiments of the present invention are described with reference to the figures.

### BRIEF DESCRIPTION OF THE DRAWINGS

FIG. 1 is a schematic representation of a method for recognizing an event according to one example embodiment of the present invention.

FIG. 2, which includes diagrams a) and b), is a schematic representation of an application of a matched filter arrangement for recognizing an event according to one example embodiment of the present invention.

FIG. 3, which includes diagrams a)-f), is a further schematic representation of an application of a matched filter arrangement for recognizing an event according to a further example embodiment of the present invention.

FIG. 4 is a schematic representation of a method for generating a matched filter arrangement for use in recognizing an event according to a further example embodiment of the present invention.

FIG. 5 is a schematic representation of peak functions according to a further example embodiment of the present invention.

FIG. 6 is a flowchart of the method for recognizing an event according to one example embodiment of the present invention.

FIG. 7 is a further flowchart of the method for recognizing an event according to a further example embodiment of the present invention.

FIG. 8 is a further flowchart of the method for recognizing an event according to a further example embodiment of the present invention.

FIG. 9 is a flowchart of the method for generating a matched filter arrangement according to one example embodiment of the present invention.

FIG. 10 is a further flowchart of the method for generating a matched filter arrangement according to a further example embodiment of the present invention.

FIG. 11 is a schematic representation of a system for recognizing an event according to one example embodiment of the present invention.

FIG. 12 is a schematic representation of a computer program product, according to an example embodiment of the present invention.

### DETAILED DESCRIPTION OF EXAMPLE EMBODIMENTS

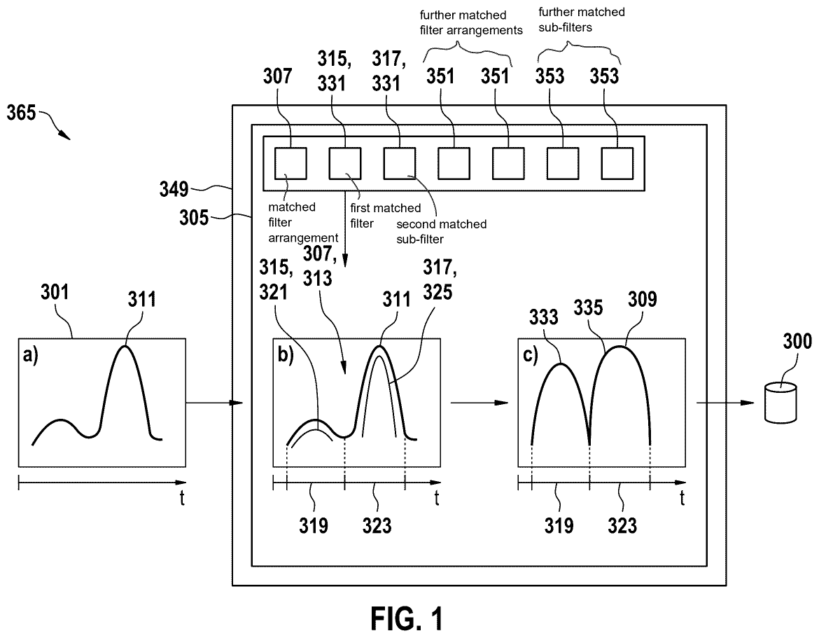

FIG. 1 is a schematic representation of a method 100 for recognizing an event 300 according to one embodiment.

FIG. 1 shows various steps of the method 100 according to the present invention for recognizing an event 300. The method is executed by a system 365 that comprises at least one event recognition unit 305 that is executed on a computing unit 349.

In order to recognize an event 300, sensor data 301 are initially received by the event recognition unit 305. The sensor data 301 are in the form of time series data and depict the event 300 to be recognized. Here, the time series exhibits a temporal progression 311. Here, the sensor data 301 can in particular be live data that are recorded during operation of the system. Here, the sensor data 301 are received continuously.

In order to recognize the event 300, the sensor data 301 in the form of time series data are filtered by applying a matched filter arrangement 307. The matched filter arrangement 307 exhibits a temporal progression 313 that at least partially corresponds to the temporal progression 311 of the sensor data 301.

Here, the sensor data 301 are shown in diagram a). Fig. b) shows the filtering process of the sensor data 301 by applying the matched filter arrangement 307 according to a convolution of the sensor data 301 having the matched filter arrangement 307.

The matched filter arrangement 307 having the temporal progression 313 corresponding to the temporal progression 311 of the sensor data 301 is hereby designed as a matched filter and is optimized to filter sensor data 301 that depict the event 300 to be recognized. For sensor data 301 that depict a different event 300 or no event 300 at all, optimal filtering is not achieved by the particular matched filter arrangement 307.

According to the present invention, the matched filter arrangement 307 comprises a first matched filter 315 and a second matched sub-filter 317. The first matched sub-filter 315 is optimized for a first time segment 319 of the sensor data 301. The second matched sub-filter 317 is optimized accordingly for a second time segment 323. The first matched sub-filter 315 exhibits a first temporal progression 321 and the second matched sub-filter 317 exhibits a second temporal progression 325. The first temporal progression 321 of the first matched sub-filter 315 corresponds at least partially to the temporal progression 311 of the sensor data 301 in the first time segment 319. The second temporal progression 325 of the second matched sub-filter 317 accordingly corresponds at least partially to the temporal progression 311 of the sensor data 301 in the second time segment 323.

In the embodiment shown, the first and second matched sub-filters 315, 317 are shown with corresponding first and second temporal progressions 321, 325, which correspond to the temporal progression 311 of the sensor data 301. The first and second temporal progressions 321, 325 are shown offset with respect to the temporal progression 311 of the sensor data 301. This is only intended to improve presentation. In reality, the first and second temporal progressions 321, 325 of the first and second matched sub-filters 315, 317 correspond to the temporal progression 311 of the sensor data 301, as is conventional for matched filter elements.

After filtering the sensor data 301 by the matched filter arrangement 307, correspondingly filtered sensor data 309 are generated.

According to the present invention, the filtering of the sensor data 301 by the matched filter arrangement 307 is carried out in such a way that the individual matched sub-filters 315, 317 are in each case applied individually to the sensor data 301 and in this case filtered sensor data 309 are generated. Since the matched sub-filters 315, 317 are in each case optimized for different sub-sections of the sensor data 301, the filtered sensor data 309 in each case exhibit corresponding peaks at these sub-sections if the sensor data 301 depict the particular feature, i.e. if the correct matched sub-filters 315, 317 have been applied.

In diagram c), a combination of the filtered sensor data from the individual applications of the matched sub-filters 315, 317 is shown as the filtered sensor data 309, which exhibit the peaks of the two matched sub-filters 315, 317.

Accordingly, the filtered sensor data 309 in each case show a first peak 333 in the first time segment 319 and a second peak 335 in the second time segment 323.

The peaks 333, 335 result from the convolution of the sensor data 301 and the matched filter arrangement 307:

$$( \tilde{f} * {g}_{N} ) [ n ] = {\sum }_{m = 0}^{N} c f [ m ] g [ n - m ] = c {\sum }_{m = 0}^{N} f [ m ] g [ n - m ]$$

Where g represents the sensor data 301 and f represents the matched filter arrangement 307.

The first peak 333 is based on the optimal filtering of the sensor data 301 by the first matched sub-filter 315 in the first time segment 319. The second peak 335 is based on the optimal filtering of the sensor data 301 in the second time segment 323 by the second matched sub-filter 317.

Based on the first and second peaks 333, 335 of the filtered sensor data 309, the event 300 depicted by the sensor data 301 is recognized in the embodiment shown.

Here, the first peak 333 in the first time segment 319 is identified with the matched filters of the sensor data 301 by the first matched sub-filter 315. Accordingly, the second peak 335 in the second time segment 323 is interpreted by optimally filtering the sensor data 301 by the second matched sub-filter 317. These two optimal filtering processes of the sensor data 301 by the first and second matched sub-filters 315, 317 are interpreted with the optimal filtering of the sensor data 301 by the matched filter arrangement 307. Since the matched filter arrangement 307 is optimized to filter sensor data 301 that depict the event 300 to be recognized, the presence of the first and second peaks 333, 335 is interpreted as the recognition of the event 300.

In the embodiment shown, the matched filter arrangement 307, the first matched sub-filter 315 and the second matched sub-filter 317 are stored in the event recognition unit 305. The first and second matched sub-filters 315, 317 are in each case stored with an identifier, which makes a unique identification of the first and second matched sub-filters 315, 317 possible. Furthermore, the first and second matched sub-filters 315, 317 can be stored with additional information with respect to the first and second time segments 319, 323, in which the first and second matched sub-filters 315, 317 are optimized for optimal filtering of the sensor data 301.

According to one embodiment, the matched filter arrangement 307 is stored as an arrangement rule in which, on the one hand, the respective matched sub-filters 315, 317 are defined, which are in each case part of the matched filter arrangement 307, and in which, on the other hand, the temporal arrangement of the respective matched sub-filters 315, 317 is defined.

In order to filter the sensor data 301 by means of the event recognition unit 305, the matched filter arrangement 307 is read out and the first and second matched sub-filters 315, 317 assigned to the matched filter arrangement 307 are arranged in a corresponding temporal arrangement to one another and executed as a filter.

According to one embodiment, the matched filter arrangement 307 can also comprise any number of more than two matched sub-filters 315, 317 that are optimized for different time segments 319, 323 of the sensor data 301.

In the embodiment shown, further matched filter arrangements 351 and further matched sub-filters 353 are stored in the event recognition unit 305. Here, the further matched filter arrangements 351 are in each case optimized for filtering sensor data 301 that depict an event 300 other than the one shown. Due to the plurality of matched filter arrangements 351, different events 300 can thus be recognized according to the method described above.

For this purpose, the matched filter arrangements 307, 351 are assigned to the respective different events 300. When the sensor data 301 are filtered by one of the plurality of matched filter arrangements 307, 353, the generation of correspondingly filtered sensor data 309 having peaks 333, 335 in the respectively expected time segments 319, 323 is taken as evidence of the presence of the event assigned to the particular executed matched filter arrangement 307, 351, and the particular event is thus recognized.

According to one embodiment, different matched sub-filters 315, 317, 353 are part of different matched filter arrangements 351.

According to one embodiment, the sensor data 305 can be in the form of multidimensional sensor data 301. In FIG. 1, only one dimension of the sensor data 301 is shown. For example, the sensor data 301 can be data from an acceleration sensor and/or gyroscope sensor and can depict translational accelerations as well as rotational accelerations.

According to one embodiment, the matched filter arrangement can be executed as follows.

Initially, matched sub-filter f having a width, i.e. a number of sample points N and a unit amplitude:

$$f ( n ) , n ∈ ℤ and 0 \leq n \leq N$$

And applied to a time series signal s (t) at time t:

$$s ( t ) , t ∈ ℤ$$

The corresponding convolution signal is obtained as:

$$g ( t ) = ( f * s ) [ t ] = {\sum }_{n = 0}^{N} f ( n ) g ( t - n ) , ( t , n ) ∈ ℤ$$

If the convolution signal g exhibits a peak at time tₚ, then for the peak to be considered a detection of an event by the particular sub-matched filter f, the value g(tₚ) must be close to a sum of squares of the filter f. This results in the same value as if the filter f were convolved with itself. The required proximity of the value g(tₚ) to the sum of squares is defined by the filter parameter ε∈[0,1). According to the embodiment described, the following constraint on the value of the filtered signal can be taken into account:

$$( 1 - ℰ ) {\sum }_{n = 0}^{N} {f}^{2} ( n ) \leq g ( {t}_{p} ) \leq ( 1 + ℰ ) {\sum }_{n = 0}^{N} {f}^{2} ( n ) \qquad 1 )$$

If g(tₚ) meets this peak limit value, this is interpreted as a detection of the particular event by the matched sub-filter f.

If a further matched sub-filter \tilde{f} is now defined that exhibits the same width but a different amplitude c than the matched sub-filter f, the following applies:

$$\tilde{f} = c \cdot f$$

Here, the resulting convolution signal \tilde{g}(t) results as:

$$\tilde{g} ( t ) = ( \tilde{f} * s ) [ t ] = {\sum }_{n = 0}^{N} c f ( n ) g ( t - n ) = c {\sum }_{n = 0}^{N} f ( n ) g ( t - n ) = c g ( t )$$

The above formula 1) thus becomes:

$$\begin{matrix}( 1 - ℰ ) {\sum }_{n = 0}^{N} {c}^{2} {f}^{2} ( n ) \leq c g ( {t}_{p} ) \leq ( 1 + ℰ ) {\sum }_{n = 0}^{N} {c}^{2} {f}^{2} ( n ) ⇒ \\ c ( 1 - ℰ ) {\sum }_{n = 0}^{N} {f}^{2} ( n ) \leq g ( {t}_{p} ) \leq c ( 1 + ℰ ) {\sum }_{n = 0}^{N} {f}^{2} ( n )\end{matrix}$$

Therefore, a change in amplitude effectively results in a change in the peak limit value of the filtered signal. Consequently, one filter can be used for all matched sub-filters having the same peak width and only the peak amplitude of the particular filter can be adapted by applying the respective amplitude scaling factors c to the peak limit value. However, filters having different peak widths still require different convolution processes.

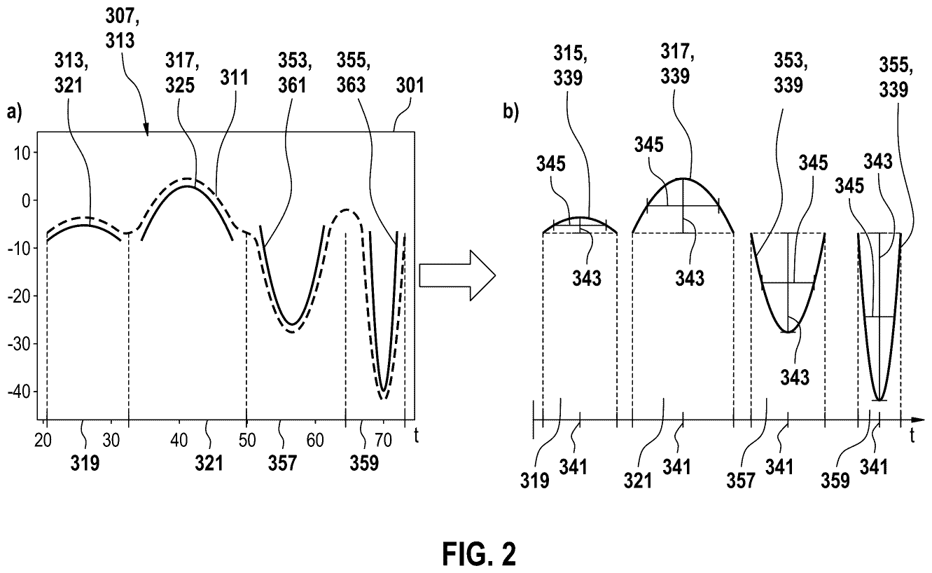

FIG. 2 is a schematic representation of an application of a matched filter arrangement 307 for recognizing an event 300 according to one embodiment.

FIG. 2 in turn shows a temporal progression 311 of sensor data 301 and a temporal progression 313 of a matched filter arrangement 307. In the embodiment shown, the matched filter arrangement 307 comprises a first matched sub-filter 315, a second matched sub-filter 317, a third matched sub-filter 353 and a fourth matched sub-filter 355. The first matched sub-filter 315 exhibits a first temporal progression 321. The second matched sub-filter 317 exhibits the second temporal progression 325. The third matched sub-filter 353 exhibits a third temporal progression 361. The fourth matched sub-filter 355 exhibits a fourth temporal progression 363. The first matched sub-filter 315 is optimized for the first time segment 319. The second matched sub-filter 317 is optimized for the second time segment 323. The third matched sub-filter 353 is optimized for the third time segment 357. The fourth matched sub-filter 355 is optimized for the fourth time segment 359.

The first to fourth matched sub-filters 315, 317, 353, 355 in each case exhibit a peak-shaped temporal progression 321, 325, 361, 363. Here, the first and second temporal progressions 321, 325 are in the form of regular peaks, while the third and fourth temporal progressions 361, 363 are in the form of inverted peaks.

Here, diagram a) shows the optimal fit of the first to fourth temporal progressions 321, 325, 361, 363 to the temporal progression 311 of the sensor data 301.

In diagram b), only the temporal progressions 321, 325, 361, 363 of the first to fourth matched sub-filters 315, 317, 353, 355 are shown. The temporal progressions 321, 325, 361, 363 are shown as peak functions 339. The peak functions 339 are in each case characterized by a peak position value 341, a peak amplitude value 343 and a peak width value 345.

According to the different formations of the different peaks of the temporal progression 311 of the sensor data 301, the peak functions 339 of the first to fourth matched sub-filters 315, 317, 353, 355 exhibit correspondingly different peak position values 341, different peak amplitude values 343 and different peak width values 345.

According to the embodiment shown, the peak function 339 exhibits curves of a sinusoidal half-wave. Alternatively, the peak functions 339 can also exhibit, for example, a Gaussian peak shape or a Lorentzian peak shape.

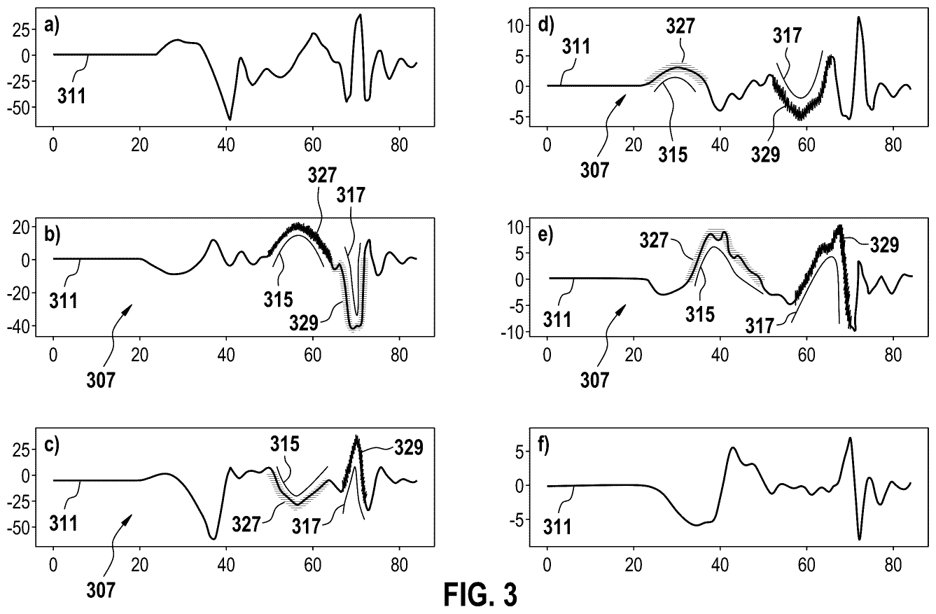

FIG. 3 is a further schematic representation of an application of a matched filter arrangement 307 for recognizing an event 300 according to a further embodiment.

In the diagrams a) to f), different temporal progressions 311 of sensor data 301 are shown. The diagrams a) to c) represent three dimensions of a translational acceleration in the embodiment shown. The diagrams d) to f) represent three dimensions of a rotational acceleration.

In the diagrams b) to e), in addition to the temporal progressions 311 of the sensor data 301, temporal progressions 321, 325 of the first and second matched sub-filters 315, 317 are shown. In the embodiments shown, the first and second matched sub-filters 315, 317 are in each case adapted to first and second characteristic features 327, 329 of the temporal progressions 311 of the sensor data 301.

The characteristic features 327, 329 are characterized by segments of the temporal progressions 311 of the sensor data that exhibit a signal-to-noise ratio that is greater than or equal to a predefined limit value and/or that exhibit a variation that is less than or equal to a further predefined limit value. The variations relate to the differences between the different temporal progressions 311 of diagrams a) to f). The diagrams a) to f) represent different dimensions of the same sensor data 301. Each temporal progression 311 of the different diagrams a) to f) thus depicts the same event 300.

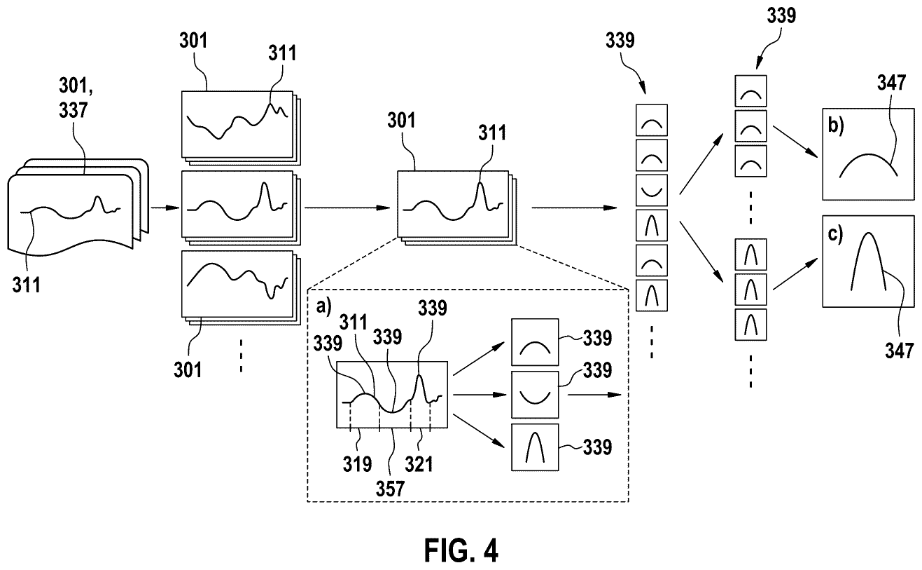

FIG. 4 is a schematic representation of a method 200 for generating a matched filter arrangement 307 for use in recognizing an event 300 according to a further embodiment.

In order to generate a matched filter arrangement 307, initially a plurality of data sets 337 of sensor data 301 in the form of time series data are received. Here, the sensor data 301 depict the same event 300.

The data sets 337 of the sensor data 301 are initially divided into the different dimensions. When the sensor data 301 are formed as acceleration data from an acceleration sensor and/or a gyroscope sensor, the different dimensions are, for example, the three dimensions of the translational acceleration and the three dimensions of the rotational acceleration. Depending on the observed movement based on the acceleration sensor data, the particular event 300 depicted by the sensor data 301 is depicted in all dimensions of the sensor data.

The generation of the matched filter arrangement 307 can thus be executed individually for each dimension.

For this purpose, initially, for a temporal progression 311 of sensor data 301, different peak functions 339 are adapted to the temporal progression 311, as shown in diagram a). The adaptation can be executed, for example, by a fitting process, in which the peak position values 341, peak amplitude values 343 and peak width values 345 of the different peak functions 339 are varied. In the diagram a) shown, three different peak functions 339, which in each case exhibit a peak-shaped curve, in particular a sinusoidal half-wave, are adapted to the different characteristic features of the temporal progression 311 of the sensor data 301.

This is executed for each temporal progression 311 of the plurality of sensor data 301 of the particular dimension of the provided data sets 337. The corresponding peak functions 339 generated thereby, which according to the example of diagram a) in each case exhibit different peak position values 341, different peak amplitude values 343 and different peak width values 345, are generated.

In the embodiment shown, the peak functions 339 generated based on the plurality of temporal progressions 311 of the sensor data 301 are grouped. In the embodiment shown, the grouping is carried out with respect to the peak position values 341, with respect to the peak amplitude values 343 and with respect to the peak width values 345.

In the embodiment shown, an averaging of the grouped peak functions 339 is further performed and correspondingly averaged peak functions 347 are generated. For example, the grouped peak functions 339 having large peak width values 345 are averaged and a corresponding averaged peak function 347 is generated, as shown in diagram b). Analogously, peak functions 339 having correspondingly small peak width values 345 are averaged and an averaged peak function 347 having a small peak width value 345 is generated accordingly, as shown in diagram c).

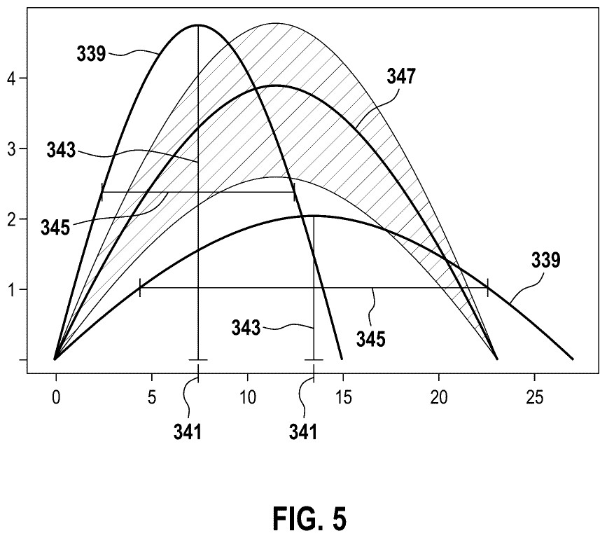

FIG. 5 is a schematic representation of peak functions 339 according to a further embodiment.

FIG. 5 shows two peak functions 339 having different peak position values 341, peak amplitude values 343 and peak width values 345. Furthermore, an averaged peak function 347 is shown, which is based on an averaging of the two peak functions 339 shown. The hatched region shows a variability of the amplitude value 343 of the averaged peak function 347.

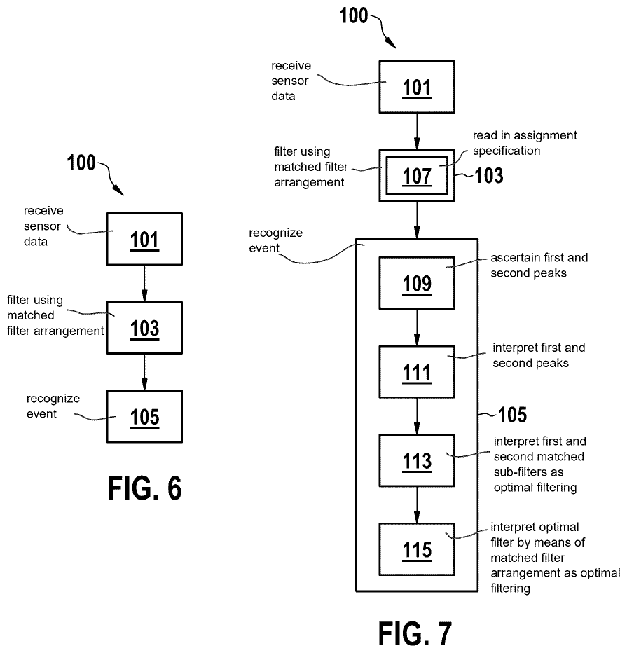

FIG. 6 is a flowchart of the method 100 for recognizing an event 300 according to one embodiment.

In order to recognize the event 300, the sensor data 301 are initially received by the event recognition unit 305 in a first method step 101.

In a further method step 103, the sensor data 301, which are formed as second series data and depict the event 300, are filtered by the matched filter arrangement 307, and filtered sensor data 309 are generated. Here, the matched filter arrangement 307 exhibits the temporal progression 313 that at least partially matches the temporal progression 311 of the sensor data 301 and is optimized for filtering the sensor data 301 depicting the event 300. The matched filter arrangement 307 comprises at least the first and second matched sub-filters 315, 317. The first and second matched sub-filters 315, 317 exhibit first and second temporal progressions 321, 325, which at least partially match the temporal progression 311 of the sensor data 301 in the first and second time segments 319, 323. The first and second matched sub-filters 315, 317 are in each case optimized for filtering the sensor data 301 depicting the event 300.

In a further method step 105, the event 300 is recognized based on the filtered sensor data 309.

FIG. 7 is a further flowchart of the method 100 for recognizing an event according to a further embodiment.

The embodiment of FIG. 7 is based on the embodiment in FIG. 6 and comprises all the method steps described therein.

In the embodiment shown, at least the matched filter arrangement 307 and the first and second matched sub-filters 315, 317 are stored in the event recognition unit 305. The matched filter arrangement 307 is an assignment specification in which the first and second matched sub-filters 315, 317 are assigned in a predefined filter sequence.

In order to filter in the method step 103, the assignment specification of the matched filter arrangement 307 is read in a method step 107 and the first and second matched sub-filters 315, 317 are arranged in the predefined filter sequence.

According to the embodiments described above, the filter sequence can provide that the first matched sub-filter 315 is arranged temporally prior to the second matched sub-filter 317. Alternatively, the first matched sub-filter 315 can be arranged temporally after the second matched sub-filter 317.

In the embodiment shown, in order to recognize the event 300, in a further method step 109 the first peak 333 in the first time segment 319 and the second peak 335 in the second time segment 323 of the filtered sensor data 309 are ascertained.

In a further method step 111, the first peak 333 in the first time segment 319 is interpreted with the matched filters of the sensor data 301 by means of the first matched sub-filter 315. The second peak 335 in the second time segment 323 is interpreted with the matched filters of the sensor data 301 by means of the second matched sub-filter 317.

In a further method step 113, the optimal filtering of the first time segment 319 of the sensor data 301 by means of the first matched sub-filter 315 and the optimal filtering of the second time segment 323 of the sensor data 301 by means of the second matched sub-filter 317 is interpreted as optimal filtering of the sensor data 301 by the matched filter arrangement 307.

In a further method step 115, the optimal filtering of the sensor data 301 by means of the matched filter arrangement 307 is interpreted with the presence of the event 300.

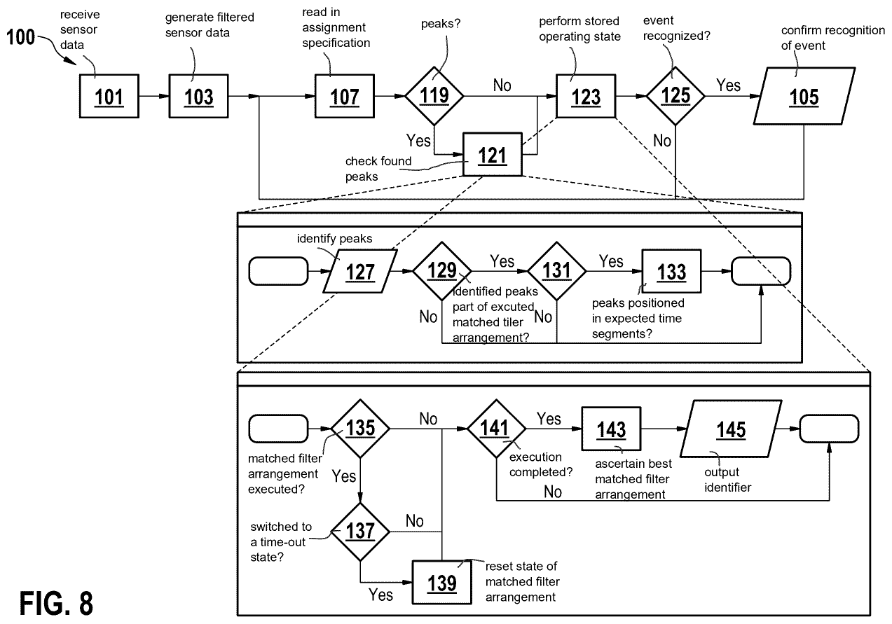

FIG. 8 is a further flowchart of the method 100 for recognizing an event according to a further embodiment.

The embodiment shown is based on the embodiment in FIG. 1 and comprises all the method steps described therein.

In a method step 117, after filtering, a search for peaks 333, 335 in the filtered sensor data 309 is executed.

In a method step 119, it is checked whether peaks 333, 335 were found in the filtered sensor data 309.

If peaks 333, 335 were found in the filtered sensor data 309, the found peaks 333, 335 are checked in a method step 121.

In order to check the peaks, the peaks 333, 335 are identified in a method step 127.

In a further method step 129, it is checked whether the identified peaks 333, 335 are part of the executed matched filter arrangement 307. This means that it is checked whether, for the corresponding matched filter arrangement 307, peaks are to be expected at the particular location in the filtered sensor data 309 at which the detected peaks 333, 335 were ascertained.

If the ascertained peaks 333, 335 are part of the executed matched filter arrangement 307, a further method step 131 checks whether the peaks 333, 335 are positioned in the expected time segments 319, 323 of the filtered sensor data 309.

If the ascertained peaks 333, 335 are positioned in the expected time segments 319, 323, a state of the matched filter arrangement 307 is updated in a further method step 133. Here, the state describes that a successful detection of expected peaks 333, 335 in the filtered sensor data 309 was effected and, based on this, optimal filtering of the sensor data 301 was effected by the particular matched filter arrangement 307.

However, if it is recognized in the method step 129 that the ascertained peaks 333, 335 are not part of the matched filter arrangement 307, or if it is recognized in the method step 131 that the ascertained peaks are not positioned in the expected time segments, the check of the peaks 333, 335 is terminated.

If, however, it is recognized in the method step 119 that no peaks 333, 335 were ascertained in the averaged sensor data 309, an operating state of the event recognition unit 305 or of the matched filter arrangements 307, 351 stored there is performed in a method step 123.

For this purpose, in a method step 135 it is checked whether a matched filter arrangement 307, 351 of the event recognition unit 305 is executed.

If a corresponding execution is affirmed, in a further method step 137 it is checked whether a matched filter arrangement is switched to a time-out state.

If a corresponding time-out is affirmed, the state of the matched filter arrangement is reset in a further method step 139.

However, if the check in the method step 135 ascertains that no matched filter arrangement is being executed or if it is ascertained in the method step 137 that no matched filter arrangement is switched to a time-out state, a further method step 141 checks whether an execution of a matched filter arrangement 307 has been completed.

If a corresponding conclusion of a matched filter arrangement 307, 351 is affirmed, the best matched filter arrangement 307, 351 is ascertained in a further method step 143 based on a previously created score value. Here, the best matched filter arrangement 307, 351 is characterized in that the respectively ascertained peaks 333, 335 exhibit a best fit to the expected peaks within the filtered sensor data 309 for the particular matched filter arrangement 307, 351.

In a further method step 145, the identifier of the matched filter arrangement 307, 351 having the best score value is output.

In a further method step 125, it is checked whether the particular event 300 was recognized.

If this is affirmed, the recognition of event 105 is confirmed in the method step 105.

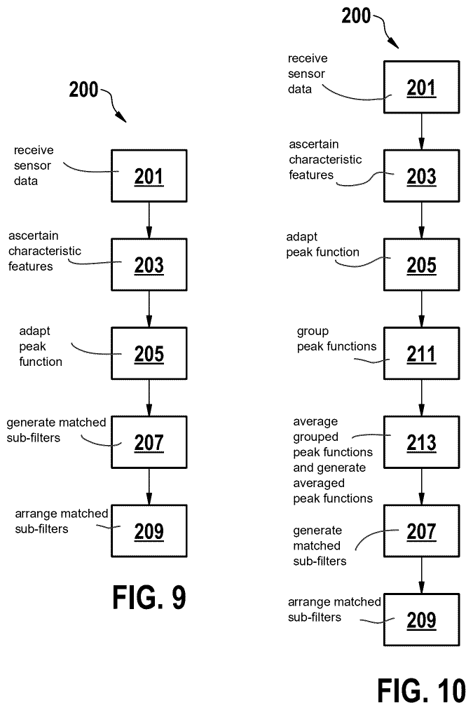

FIG. 9 is a flowchart of the method 200 for generating a matched filter arrangement 307 according to one embodiment.

In order to generate a matched filter arrangement 307, data sets 337 of sensor data 301 are initially received in a method step 201. Here, the sensor data 301 are in turn in the form of time series data and depict the same result 300.

In a further method step 203, characteristic features 327, 329 are ascertained within the temporal progressions 311 of the sensor data 301.

In a further method step 205, peak functions 339 are adapted to the characteristic features 327, 329 of the temporal progressions 311 of the sensor data 301. For each peak function 339, in each case a peak position value 341 and/or a peak amplitude value 343 and/or a peak width value 345 are ascertained.

In a further method step 207, the matched filter 315, 317 is generated according to the temporal progressions 321, 325 of the peak functions 339. Here, the matched sub-filter 315, 317 exhibits a temporal progression 321, 325, which at least partially matches the temporal progression of the particular peak function 339.

In a further method step 209, the correspondingly generated matched sub-filters 315, 317 are arranged relative to one another in the matched filter arrangement 307 according to the position values 341. The matched filter arrangement 307 thus exhibits a temporal progression 313 that at least partially corresponds to the temporal progression 311 of the sensor data 301. Here, the temporal progression 313 of the matched filter arrangement 307 is given by the temporal progressions 321, 325 of the respective matched sub-filters 315, 317.

FIG. 10 is a further flowchart of the method 200 for generating a matched filter arrangement 307 according to a further embodiment.

The embodiment in FIG. 10 is based on the embodiment in FIG. 9 and comprises all the method steps described therein.

In the embodiment shown, in a method step 211, the peak functions 339 ascertained for the same events 300 from the sensor data 301 of the different data sets 337 are grouped according to peak position values 341 and/or peak amplitude values 343 and/or peak width values 345.

In a further method step 213, the grouped peak functions 339 are averaged and corresponding averaged peak functions 347 are generated.

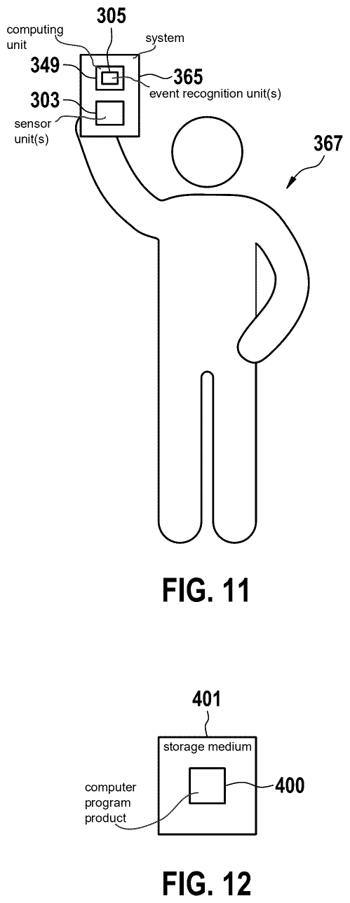

FIG. 11 is a schematic representation of a system 365 for recognizing an event 300 according to one embodiment.

In the embodiment shown, the system 365 comprises the event recognition unit 305 executable on the computing unit 349 and at least one sensor unit 303. In the embodiment shown, the sensor unit 303 is designed as an acceleration sensor and/or gyroscope sensor. The system 365 can be held by a user 367 and, in the embodiment shown, events configured as gestures of the user 367 can be recognized based on the acceleration values of the sensor unit 303 by the method described above.

FIG. 12 is a schematic illustration of a computer program product 400 comprising instructions that, when the program is executed by a data processing unit, cause the data processing unit to carry out the method 100 for detecting an event and/or the method 200 for generating a matched filter arrangement 307.

In the embodiment shown, the computer program product 400 is stored on a storage medium 401. Here, the storage medium 401 can be any storage medium from the related and/or prior art.

What is claimed is:

1. A computer-implemented method for recognizing an event, the method comprising the following steps:
receiving sensor data from at least one sensor unit using an event recognition unit, wherein the sensor data are in a form of time series data and depict the event;
filtering the sensor data through a matched filter arrangement of the event recognition unit and generating filtered sensor data, wherein the matched filter arrangement exhibits a temporal progression that at least partially matches a temporal progression of the sensor data depicting the event and is optimized for filtering the sensor data depicting the event, wherein the matched filter arrangement includes at least a first matched sub-filter and a second matched sub-filter, wherein each of the first and second matched sub-filters is a matched filter, wherein the first matched sub-filter exhibits a first temporal progression that at least partially matches the temporal progression of the sensor data in a first time segment of the sensor data and is optimized for filtering the first time segment of the sensor data depicting the event, and wherein the second matched sub-filter includes a second time segment that at least partially matches the temporal progression of the sensor data in a second time segment of the sensor data and is optimized for filtering the second time segment of the sensor data depicting the event; and
recognizing the event based on the filtered sensor data using the event recognition unit.

2. The method according to claim 1, wherein: (i) the first matched sub-filter is optimized for filtering a first characteristic feature of the sensor data depicting the event, and/or (ii) the second matched sub-filter is optimized for filtering a second characteristic feature of the sensor data depicting the event.

3. The method according to claim 2, wherein the first and/or the second characteristic feature of the sensor data is formed as a portion of the sensor data: (i) having a signal-to-noise ratio that reaches or exceeds a predefined limit value and/or having a variance between different sensor data depicting the same event that reaches or falls below a further predefined limit value.

4. The method according to claim 1, wherein the first and second temporal progressions of the first and second matched sub-filters each exhibits a peak shape.

5. The method according to claim 1, wherein the first and second temporal progressions of the first and second matched sub-filters each exhibits a shape of a sinusoidal half-oscillation.

6. The method according to claim 1, wherein each of the first and second matched sub-filters is stored in the event recognition unit with a predefined identifier and information with respect to the first and second time segments, and wherein each of the first and second matched sub-filters is uniquely identifiable via the identifier.

7. The method according to claim 1, wherein the matched filter arrangement is stored as an assignment specification in the event recognition unit, wherein the assignment specification assigns the first and second matched sub-filters to a predefined filter sequence, and wherein the filtering includes:
reading the assignment specification and arranging the first and second matched sub-filters in the predefined filter sequence.

8. The method according to claim 1, wherein a plurality of matched filter arrangements and a plurality of matched sub-filters are stored in the event recognition unit, wherein each of the matched filter arrangements is optimized for filtering sensor data depicting different events relative to the others of the match filter arrangements.

9. The method according to claim 8, wherein at least one matched sub-filter is assigned to at least two different matched filter arrangements.

10. The method according to claim 1, wherein the recognition of the event includes:
ascertaining a first peak in the first time segment of the filtered sensor data and a second peak in the second time segment of the filtered sensor data;
interpreting the first peak in the first time segment as an optimal filtering of the first time segment of the sensor data using the first matched sub-filter and interpreting the second peak in the second time segment of the filtered sensor data as an optimal filtering of the second time segment of the sensor data using the second matched sub-filter;
interpreting the optimal filtering of the first time segment of the first sensor data using the first matched sub-filter and the second time segment of the sensor data using the second matched sub-filter, as optimal filtering of the sensor data by the matched filter arrangement; and
interpreting the optimal filtering of the sensor data using the matched filter arrangement optimized for filtering sensor data depicting the event as a presence of the event in the sensor data.

11. The method according to claim 1, wherein: (i) the sensor data are data from an acceleration sensor and/or a gyroscope sensor, and/or (ii) the event is a gesture of a person.

12. A computer-implemented method for generating a matched filter arrangement, comprising the following steps:
receiving a plurality of data sets of sensor data from at least one sensor unit, wherein the sensor data are in a form of time series data and depict the event;
ascertaining characteristic features within temporal progressions of the sensor data of the plurality of data sets;
adapting peak functions to the characteristic features of the temporal progressions of the sensor data and ascertaining for each of the peak functions: (i) a peak position value and/or (ii) a peak amplitude value and/or (iii) a peak width value;
generating matched sub-filters according to temporal progressions of the peak functions, wherein the matched sub-filters exhibit temporal progressions that at least partially match the temporal progressions of the peak functions; and
arranging the matched sub-filters according to the position values relative to one another as a matched filter arrangement, wherein the matched filter arrangement exhibits a temporal progression that at least partially matches the temporal progression of the sensor data and is optimized to filter the sensor data depicting the event.

13. The method according to claim 12, further comprising:
grouping the peak functions ascertained for the same event from sensor data of different ones of the data sets according to the position values and/or the amplitude values and/or the peak width values; and
averaging the grouped peak functions and generating averaged peak functions.

14. The method according to claim 12, wherein the sensor data are in a form of multi-dimensional sensor data, and wherein the generation of the matched sub-filters is performed separately for different dimensions of the sensor data.

15. A computing unit configured to execute a method for recognizing an event, the method comprising the following steps:
receiving sensor data from at least one sensor unit using an event recognition unit, wherein the sensor data are in a form of time series data and depict the event;
filtering the sensor data through a matched filter arrangement of the event recognition unit and generating filtered sensor data, wherein the matched filter arrangement exhibits a temporal progression that at least partially matches a temporal progression of the sensor data depicting the event and is optimized for filtering the sensor data depicting the event, wherein the matched filter arrangement includes at least a first matched sub-filter and a second matched sub-filter, wherein each of the first and second matched sub-filters is a matched filter, wherein the first matched sub-filter exhibits a first temporal progression that at least partially matches the temporal progression of the sensor data in a first time segment of the sensor data and is optimized for filtering the first time segment of the sensor data depicting the event, and wherein the second matched sub-filter includes a second time segment that at least partially matches the temporal progression of the sensor data in a second time segment of the sensor data and is optimized for filtering the second time segment of the sensor data depicting the event; and
recognizing the event based on the filtered sensor data using the event recognition unit.

16. A non-transitory computer-readable medium on which is stored a computer program product including instructions for recognizing an event, the instructions, when executed by a data processor, causing the data processor to perform the following steps:
receiving sensor data from at least one sensor unit using an event recognition unit, wherein the sensor data are in a form of time series data and depict the event;
filtering the sensor data through a matched filter arrangement of the event recognition unit and generating filtered sensor data, wherein the matched filter arrangement exhibits a temporal progression that at least partially matches a temporal progression of the sensor data depicting the event and is optimized for filtering the sensor data depicting the event, wherein the matched filter arrangement includes at least a first matched sub-filter and a second matched sub-filter, wherein each of the first and second matched sub-filters is a matched filter, wherein the first matched sub-filter exhibits a first temporal progression that at least partially matches the temporal progression of the sensor data in a first time segment of the sensor data and is optimized for filtering the first time segment of the sensor data depicting the event, and wherein the second matched sub-filter includes a second time segment that at least partially matches the temporal progression of the sensor data in a second time segment of the sensor data and is optimized for filtering the second time segment of the sensor data depicting the event; and
recognizing the event based on the filtered sensor data using the event recognition unit.
